(19) United States
(12) Patent Application Publication
(10) Pub. No.: US 2026/0179656 A1
(43) Pub. Date: Jun. 25, 2026

(54) MULTIMEDIA RESOURCE PROCESSING METHOD AND APPARATUS, AND DEVICE AND MEDIUM

(71) Applicant: Beijing Zitiao Network Technology Co., Ltd., Beijing (CN)

(72) Inventors: Keyu CHEN, Beijing (CN); Kaibo CHU, Beijing (CN); Liyu LIANG, Beijing (CN); Junyue CAO, Beijing (CN); Feng ZHOU, Beijing (CN); Binbin XU, Beijing (CN); Can LI, Beijing (CN); Yingnan WANG, Beijing (CN)

(21) Appl. No.: 19/126,076

(22) PCT Filed: Nov. 13, 2023
(86) PCT No.: PCT/CN2023/131371

§ 371 Date: Apr. 30, 2025

(30) Foreign Application Priority Data
Nov. 14, 2022 (CN) 2022114194971

(51) Int. Cl. G11B 27/036; G11B 27/10

(52) U.S. Cl. CPC G11B 27/036; G11B 27/105

(57) ABSTRACT

The present disclosure relates to a multimedia resource processing method and apparatus, a device, and a medium. The method includes: acquiring a multimedia editing draft to be composited, where the multimedia editing draft includes an initial multimedia resource and editing information; performing segmentation processing on the multimedia editing draft to obtain a plurality of draft segments; for the plurality of draft segments, performing composite processing on the different draft segments using different processors to obtain target multimedia resource segments corresponding to the plurality of draft segments; and compositing the plurality of target multimedia resource segments to obtain a target multimedia resource corresponding to the multimedia editing draft, where the target multimedia resource is a multimedia resource obtained after an editing operation indicated by the editing information is performed on the initial multimedia resource.

### CROSS-REFERENCE TO RELATED APPLICATION(S)

This application claims priority to the Chinese Patent Application No. 202211419497.1, filed on Nov. 14, 2022, the disclosure of which is incorporated herein by reference in its entirety.

### FIELD

The present disclosure relates to the technical field of multimedia processing, and in particular, to a multimedia resource processing method and apparatus, a device, and a medium.

### BACKGROUND

With the popularity of multimedia editing applications, more and more users are utilizing the multimedia editing applications for editing, such as adding various materials such effects, images, and texts to videos, and composite final videos through the multimedia editing applications. However, current multimedia resource composition usually takes a long time, and the users need to wait for a long time to obtain final required multimedia resources, resulting in poor experience.

### SUMMARY

In order to solve the above technical problems or at least partially solve the above technical problems, the present disclosure provides a multimedia resource processing method and apparatus, a device, and a medium.

An embodiment of the present disclosure provides a multimedia resource processing method. The method includes: acquiring a multimedia editing draft to be processed, where the multimedia editing draft includes an initial multimedia resource and editing information, the editing information is used to indicate an editing operation on the initial multimedia resource, and the initial multimedia resource includes an initial video resource and/or an initial audio resource; performing segmentation processing on the multimedia editing draft to obtain a plurality of draft segments, where draft segments include multimedia resource segments from the initial multimedia resource and editing information segments from the editing information, and the editing information segments are used to indicate editing operations on the multimedia resource segments; for the plurality of draft segments, performing composite processing on the different draft segments using different processors respectively to obtain target multimedia resource segments corresponding to the plurality of draft segments, where the target multimedia resource segments are multimedia resources obtained after the editing operations indicated by the editing information segments are performed on the multimedia resource segments; and compositing the plurality of target multimedia resource segments to obtain a target multimedia resource corresponding to the multimedia editing draft, where the target multimedia resource is a multimedia resource obtained after the editing operation indicated by the editing information is performed on the initial multimedia resource.

Optionally, the step of performing segmentation processing on the multimedia editing draft to obtain a plurality of draft segments includes: determining a draft segment count according to a total duration of the initial multimedia resource; and performing, based on the draft segment count, segmentation processing on the multimedia editing draft to obtain the plurality of draft segments.

Optionally, the step of determining a draft segment count according to a total duration of the initial multimedia resource includes: acquiring a target resolution corresponding to the initial multimedia resource; and determining the draft segment count according to the total duration of the initial multimedia resource and the target resolution.

Optionally, the step of determining the draft segment count according to the total duration of the initial multimedia resource and the target resolution includes: acquiring a maximum segment count and a preset single-segment duration corresponding to the target resolution when the total duration is greater than a duration threshold; and determining the draft segment count according to the maximum segment count, the total duration, and the preset single-segment duration.

Optionally, the step of determining the draft segment count according to the maximum segment count, the total duration, and the preset single-segment duration includes: if a ratio of the total duration to the preset single-segment duration is less than the maximum segment count, determining the draft segment count based on the ratio; and if the ratio of the total duration to the preset single-segment duration is not less than the maximum segment count, using the maximum segment count as the draft segment count.

Optionally, the step of performing, based on the draft segment count, segmentation processing on the multimedia editing draft to obtain the plurality of draft segments includes: performing even segmentation processing on the initial multimedia resource in the multimedia editing draft based on the draft segment count to obtain a plurality of multimedia resource segments; segmenting the editing information in the multimedia editing operation according to the plurality of multimedia resource segments to obtain editing information segments respectively corresponding to the different multimedia resource segments; and obtaining the plurality of draft segments based on the plurality of multimedia resource segments and the editing information segments respectively corresponding to the different multimedia resource segments.

Optionally, there are partially overlapping resources between the adjacent multimedia resource segments.

Optionally, the step of performing composite processing on the different draft segments using different processors includes: using the different processors to download and preload different draft segments respectively, and performing, by the different processors, composite processing based on the respective preloaded draft segments.

Optionally, the step of compositing the plurality of target multimedia resource segments to obtain a target multimedia resource respectively corresponding to the multimedia editing draft includes: concatenating the plurality of target multimedia resources according to time information corresponding to the different target multimedia resources, to obtain the target multimedia resource corresponding to the multimedia editing draft.

Optionally, the initial multimedia resource includes the initial video resource, and the target multimedia resource segments corresponding to the processors do not carry an audio stream corresponding to the initial video resource. The step of compositing the plurality of target multimedia resource segments to obtain a target multimedia resource corresponding to the multimedia editing draft includes: encoding the audio stream corresponding to the initial video resource through other processors in addition to the processors corresponding to the plurality of draft segments, to obtain an encoded audio stream; and merging the plurality of target multimedia resource segments and the encoded audio stream to obtain the target multimedia resource corresponding to the multimedia editing draft.

An embodiment of the present disclosure further provides a multimedia resource processing apparatus, including: a draft acquiring module, configured to acquire a multimedia editing draft to be processed, where the multimedia editing draft includes an initial multimedia resource and editing information, the editing information is used to indicate an editing operation on the initial multimedia resource, and the initial multimedia resource includes an initial video resource and/or an initial audio resource; a draft segmentation module, configured to perform segmentation processing on the multimedia editing draft to obtain a plurality of draft segments, where draft segments include multimedia resource segments from the initial multimedia resource and editing information segments from the editing information, and the editing information segments are used to indicate editing operations on the multimedia resource segments; a first composition module, configured to perform, for the plurality of draft segments, composite processing on the different draft segments using different processors respectively to obtain target multimedia resource segments corresponding to the plurality of draft segments, where the target multimedia resource segments are multimedia resources obtained after the editing operations indicated by the editing information segments are performed on the multimedia resource segments; and a second composition module, configured to composite the plurality of target multimedia resource segments to obtain a target multimedia resource corresponding to the multimedia editing draft, where the target multimedia resource is a multimedia resource obtained after the editing operation indicated by the editing information is performed on the initial multimedia resource.

An embodiment of the present disclosure further provides an electronic device. The electronic device includes a processor, and a memory configured to store executable instructions of the processor, where the processor is configured to read the executable instructions from the memory, and execute the instructions to implement the multimedia resource processing method provided in this embodiment of the present disclosure.

An embodiment of the present disclosure further provides a computer-readable storage medium. The storage medium stores a computer program. The computer program is used to perform the multimedia resource processing method provided in this embodiment of the present disclosure.

An embodiment of the present disclosure further provides a computer program product, including a computer program, where the computer program, when executed by a processor, implements any one of the multimedia resource processing methods.

According to the above technical solutions provided in the embodiments of the present disclosure, the segmentation processing may be performed on the multimedia editing draft, the different draft segments are composited using the different processors to obtain the target multimedia resource segments corresponding to the plurality of draft segments, and finally the plurality of target multimedia resource segments are directly composited to obtain the target multimedia resource corresponding to the multimedia editing draft. In summary, the above method does not directly use a single processor to obtain the target multimedia resource corresponding to the multimedia editing draft. Instead, through the method for segmenting the multimedia editing draft, the corresponding draft segments are processed in parallel using the plurality of processors, and then the target multimedia resource corresponding to the draft segment obtained by each processor is further composited, and the target multimedia resource corresponding to the multimedia editing draft is finally obtained. The parallel processing method can effectively improve the multimedia resource composition efficiency and shorten the composition time of the multimedia resource, thereby well improving user experience.

It should be understood that the content described in the part is not intended to identify key or important features of the embodiments of the present disclosure, nor is it intended to limit the scope of the present disclosure. Other features of the present disclosure are easier to understand through the following description.

### BRIEF DESCRIPTION OF THE DRAWINGS

In order to describe the technical solutions in the embodiments of the present disclosure or in the prior art more clearly, the accompanying drawings required to be used in descriptions of the embodiments or the prior art will be briefly introduced below, and it is apparent that those of ordinary skill in the art may also obtain other accompanying drawings according to these accompanying drawings without creative work.

FIG. 1 is a schematic flowchart of a multimedia resource processing method according to an embodiment of the present disclosure;

FIG. 2 is a schematic diagram of video composition according to an embodiment of the present disclosure;

FIG. 3 is a schematic diagram of video composition according to an embodiment of the present disclosure;

FIG. 4 is a schematic flowchart of video composition according to an embodiment of the present disclosure;

FIG. 5 is a schematic diagram of a processing process of a multimedia editing draft according to an embodiment of the present disclosure;

FIG. 6 is a schematic diagram of a structure of a multimedia resource processing apparatus according to an embodiment of the present disclosure; and

FIG. 7 is a schematic diagram of a structure of an electronic device according to an embodiment of the present disclosure.

### DETAILED DESCRIPTION OF EMBODIMENTS

To have a more clear understanding of the above objectives, features, and advantages of the present disclosure, the solution of the present disclosure is further described below. It should be noted that the embodiments and the features of the embodiments in the present disclosure may be mutually combined without conflicts.

Many specific details are elaborated in the following description to facilitate a full understanding of the present disclosure, but the present disclosure may also be implemented in methods different from those described herein. Apparently, the embodiments in the specification are only a part rather all of the embodiments of the present disclosure.

A user may utilize a multimedia editing application to perform composite operations, such as material adding on an initial multimedia resource (e.g., a video), and composite a final required multimedia resource through the multimedia editing application. Through researches, the inventor has found that multimedia editing applications in the related art typically use a single server to perform the composite operation of the multimedia resource, which takes a long time. Correspondingly, the user waits for a long time to acquire the final required multimedia resource, resulting in poor user experience. In order to solve the above problems, an embodiment of the present disclosure provides a video composition method and apparatus, a device, and a medium, which are further described as below.

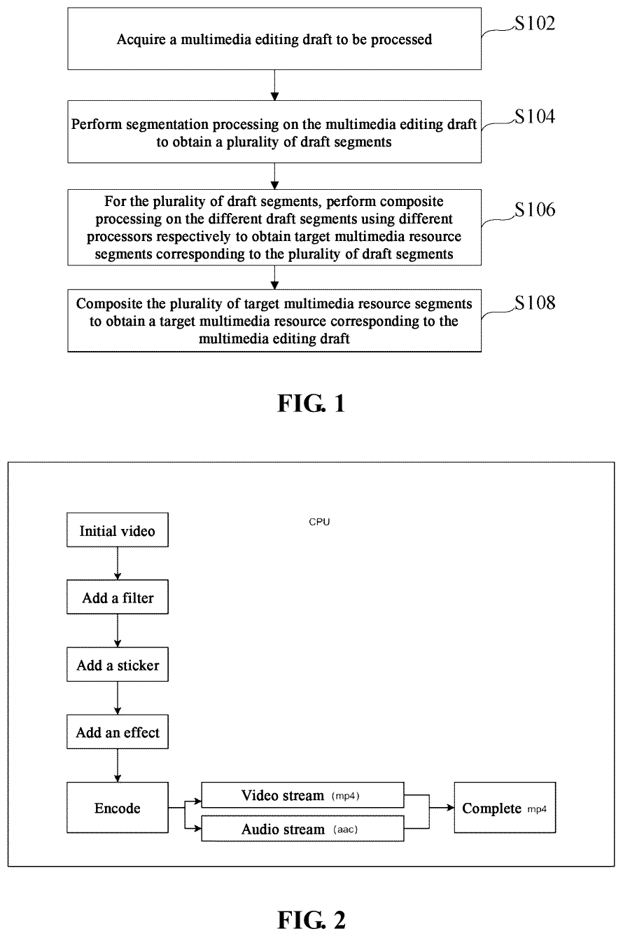

FIG. 1 is a schematic flowchart of a multimedia resource processing method according to an embodiment of the present disclosure. The method may be performed by a multimedia resource processing apparatus, where the apparatus may be implemented using software and/or hardware, is typically integrated into an electronic device, and specifically, may be performed by a processor on the electronic device. The electronic device may be any device with processing capabilities, such as a server. The processor of the electronic device may be, for example, a central processing unit (CPU) or a graphics processing unit (GPU). As shown in FIG. 1, the method mainly includes step S102 to step S108 as below:

Step S102: Acquire a multimedia editing draft to be processed, where the multimedia editing draft includes an initial multimedia resource and editing information.

In some specific examples, the initial multimedia resource includes an initial video resource and/or an initial audio resource, and further, may also include material resources such as an image, a text, a sticker, an effect, and a filter. This embodiment of the present disclosure does not limit the types and quantity of resources contained within the initial multimedia resource. The editing information is used to indicate an editing operation on the initial multimedia resource. For example, the editing information may include an editing operation sequence. The operation sequence may be used to indicate a specific processing method for the initial multimedia resource, such as a specific method for indicating composition of materials and a video. Exemplarily, taking the initial multimedia resource including the initial video resource as an example, the editing information may indicate a time point and a specific processing method for editing the initial video resource. Taking composition of a video resource and a material resource, the editing information may also include material resource information required for editing processing and a composition method for the initial video resource and the material resource. Additionally, the editing information may also include parameters of the multimedia resource set by the user. The parameters include, for example, a format and a resolution of a final multimedia resource obtained through editing, which is not limited herein.

Step S104: Perform segmentation processing on the multimedia editing draft to obtain a plurality of draft segments, where each draft segment includes a multimedia resource segment from the initial multimedia resource and an editing information segment from the editing information, and the editing information segment is used to indicate an editing operation on the multimedia resource segment.

Compared with processing the entire multimedia editing draft using a single processor (or any device including a processor, such as a server), this embodiment of the present disclosure fully considers processing time limitations imposed by processing performance of the single processor on the multimedia editing draft, thereby providing a draft segmentation solution. That is, the multimedia editing draft may be divided into the plurality of draft segments. Each processor (e.g., the CPU or the GPU) may respectively process a corresponding draft segment, that is, a task of processing one multimedia editing draft is divided into a plurality of parallel tasks, thereby effectively improving the draft processing efficiency and then effectively improving the composition efficiency of the multimedia resource.

In some implementation examples, the multimedia editing draft may be directly segmented into the plurality of draft segments according to the number of existing processors. In some other implementation examples, a draft segment count may be first determined according to the initial multimedia resource in the multimedia editing draft, and then the multimedia editing draft is segmented according to the draft segment count. In some other implementation examples, the multimedia editing draft may also be segmented when the multimedia editing draft satisfies preset conditions, thereby obtaining the plurality of draft segments. The preset conditions include, but are not limited to, a total duration of the initial multimedia resource in the multimedia editing draft being greater than a preset duration threshold.

Step S106: For the plurality of draft segments, perform composite processing on the different draft segments using different processors to obtain target multimedia resource segments corresponding to the plurality of draft segments, where the target multimedia resource segments are multimedia resources obtained after editing operations indicated by the editing information segments are performed on the multimedia resource segments. Exemplarily, assuming that there are totally N draft segments, N processors may be utilized to process the N draft segments one by one, and finally, N target multimedia resource segments are obtained.

During specific implementation, each draft segment is processed by a single processor for composition, that is, based on the editing information segment in the draft segment, editing processing is performed on the multimedia resource segment in the draft segment. For example, the audio and video resources and the material resource in the multimedia resource are composited, and then the target multimedia resource segment corresponding to the draft segment is obtained. In some specific examples, the editing information segment may indicate a specific composition method between the audio and video resources and the material resource. Each processor may perform rendering composition on the corresponding audio and video resources and material resource based on the editing information segment. For example, a material is added to a video segment according to a material addition method indicated by the editing information, and additionally, video encoding and other processing may be further performed in a video with the added material. The above rendering composition process involves decoding various materials such as a video, an image, and an effect, then performing drawing frame by frame according to a format specified in the editing information, and finally performing encoding and composition to obtain the target multimedia resource segment. For the specific steps of the rendering composition, reference may be made to the related art, which is not repeated herein. The above is merely a composition implementation example to facilitate understanding, which is not limited herein.

Step S108: Composite the plurality of target multimedia resource segments to obtain a target multimedia resource corresponding to the multimedia editing draft, where the target multimedia resource is a multimedia resource obtained after the editing operation indicated by the editing information is performed on the initial multimedia resource.

In some implementations, the plurality of target multimedia resource segments may be concatenated and composited according to a splitting sequence of the corresponding draft segments, and the target multimedia resource corresponding to the multimedia editing draft is obtained based on a concatenation result.

In summary, the above method provided in this embodiment of the present disclosure does not directly use a single processor to obtain the target multimedia resource corresponding to the multimedia editing draft. Instead, through the method for segmenting the multimedia editing draft, the corresponding draft segments are processed in parallel using the plurality of processors, and then the target multimedia resource corresponding to the draft segment obtained by each processor is further composited, and the target multimedia resource corresponding to the multimedia editing draft is finally obtained. The parallel processing method can effectively improve the multimedia resource composition efficiency and shorten the composition time of the multimedia resource, thereby well improving user experience.

In some implementations, to determine a draft segment count reasonably and objectively, analysis processing may be performed based on the duration of the initial multimedia resource. Specifically, the step of performing segmentation processing on the multimedia editing draft to obtain a plurality of draft segments may be implemented with reference to step A and step B as below.

Step A: Determine the draft segment count according to a total duration of the initial multimedia resource.

Exemplarily, the initial multimedia resource may include one or more audio and videos. Assuming that N videos are included, the total duration of the initial multimedia resource is the number of durations of the N videos. The above method fully considers the impact of the total duration of the initial multimedia resource on the resource editing processing by the processor. It should be understood that the longer the total duration of the initial multimedia resource, the longer the corresponding processing duration required by the processor. To effectively shorten the processing duration of the processor, the number of needed draft segments may be determined based on the total duration of the initial multimedia resource. In practical applications, each processor may process one draft segment, different processors process different draft segments, and therefore once the draft segment count is determined, the number of needed processors can be determined. The method is more reasonable and objective.

In some implementations, considering that both the duration of the multimedia resource and a resolution of the multimedia resource may affect the processing duration of the processor, it should be understood that a higher resolution requires a longer processing duration of the processor. Therefore, this embodiment of the present disclosure may further combine the resolution based on the duration, so as to more reasonably and objectively determine the draft segment count required by the multimedia resource, that is, the number of processors for processing the draft segments can be more reasonably determined, and specifically, the process may be implemented with reference to step A1 to step A2 as below.

Step A1: Acquire a target resolution corresponding to the initial multimedia resource, where the target resolution is an audio and video resolution finally needed after the initial multimedia resource is subjected to editing processing, and the target resolution may be acquired through the editing information.

Step A2: Determine the draft segment count according to the total duration and the target resolution of the initial multimedia resource.

Through the above steps A1 to A2, an analysis may be performed by combining the total duration and the target resolution of the initial multimedia resource, thereby more reasonably determining the draft segment count, namely determining the number of the processors needed for performing the editing operation on the initial multimedia resource. A reasonable number of processors are adopted for parallel processing, thereby facilitating further decrease in editing time of the initial multimedia resource.

In some implementation examples, step A2 may be implemented with reference to (1) to (2) as below.

(1) Acquire the maximum segment count and a preset single-segment duration corresponding to the target resolution when the total duration is greater than a duration threshold.

In practical applications, the duration threshold may be preset according to needs. Exemplarily, the duration threshold may be determined based on a preferred processing duration of a single processor. For example, the duration threshold is set to 30 s, 10 s, etc., which is not limited herein. If the total duration is not greater than the duration threshold, it indicates that the duration of the initial multimedia resource is short, one processor is directly used for rapid completion, and therefore there is no need for segmentation processing, and user experience is not influenced on the basis of saving processor resources. If the total duration is greater than the duration threshold, it indicates that the duration of the initial multimedia resource is short, a plurality of processors are preferably needed for parallel processing, and therefore the draft segment count can be further determined, thereby determining the number of the needed processors. Due to cost constraints, the number of available processors is usually limited. Therefore, the maximum segment count may be set, an optimal duration (the preset single-segment duration) for one draft segment may be preset, and the duration is a preferred processing duration of a single processor. It should be understood that the single processor may efficiently perform the editing operation on the multimedia resource within the preferred processing duration, such as a video and material composition operation. If the preferred processing duration is exceeded, the processor may be significantly burdened. If the preferred processing duration is not reached, processing capabilities of the processor cannot be brought into full play, easily causing resource wastage of the processor. In practical applications, the maximum segment count and the preset single-segment duration may be flexibly set according to needs, and different resolutions may correspond to different maximum segment counts. For example, higher resolutions require more computational power and longer processing durations of the processor. To reduce time consumption, a corresponding higher maximum segment count may be set for a higher resolution. Exemplarily, if the user requires the final edited target multimedia resource to have a resolution of 1080 P, the corresponding maximum segment count is 40, indicating that the multimedia editing draft is divided into up to 40 segments. If the user requires the final edited target multimedia resource to have a resolution of 4K (i.e., an ultra-high resolution), the corresponding maximum segment count is 50, indicating that the multimedia editing draft is divided into up to 50 segments. The preset single-segment duration (i.e., the processing duration of a single processor) corresponding to different resolutions may be the same or different. For example, the preset single-segment duration corresponding to different resolutions may be set to 30 s, or 10 s. Specifically, the preset single-segment duration may be set according to actual situations or experiments, which is not limited herein.

(2) Determine the draft segment count according to the maximum segment count, the total duration, and the preset single-segment duration.

According to this embodiment of the present disclosure, an analysis may be performed based on the maximum segment count, the total duration of the initial multimedia resource, and the preset single-segment duration, thereby comprehensively determining the number of segments needed by the multimedia editing draft. Exemplarily, reference may be made to the following for implementation:

If a ratio of the total duration to the preset single-segment duration is less than the maximum segment count, the draft segment count is determined based on the ratio. In practical applications, if the ratio is an integer, the draft segment count is made to equal the ratio. If the ratio is non-integer, the draft segment count is made to equal an integer closest to the ratio, and the integer needs to be greater than the ratio. For example, if the ratio is 3.2, the draft segment count is determined as 4. It should be understood that in this case, the duration of the target multimedia resource segment in the draft segment corresponding to each processor is the above preset single-segment duration, and taking the preset single-segment duration being 30 s as an example, the duration of the target multimedia resource segment in the draft segment corresponding to each processor is 30 s.

If the ratio of the total duration to the preset single-segment duration is not less than the maximum segment count, the maximum segment count is used as the draft segment count. If the ratio theoretically calculated is greater than or equal to the current maximum segment count, due to condition constraints, when the draft segment count theoretically needed is greater than the current allowed maximum segment count, the maximum segment count is directly used as the draft segment count. It should be understood that in this case, the duration of the target multimedia resource segment in the draft segment corresponding to each processor is the total duration of the initial multimedia resource divided by the maximum segment count.

In the above examples, the draft segment count needed for segmenting the multimedia editing draft is determined mainly based on the ratio of the total duration to the preset single-segment duration and the maximum segment count (corresponding to a maximum processor count), which is convenient and fast, and more conforms to practical scenarios. The determined draft segment count is more reasonable and reliable.

Step B: Perform segmentation processing on the multimedia editing draft based on the draft segment count to obtain the plurality of draft segments. In practical applications, even segmentation or uneven segmentation may be performed on the multimedia editing draft according to the draft segment count, which is not limited herein. To ensure a segmentation effect, in some specific implementation examples, reference may be made to step B1 to B3 for implementation as below.

Step B1: Perform even segmentation processing on the initial multimedia resource in the multimedia editing draft based on the draft segment count to obtain a plurality of multimedia resource segments. By evenly segmenting the initial multimedia resource, it is not only convenient and efficient but also facilitates decrease in the time required to process a segment logic. Different processors may also be facilitated in parallel and synchronous processing on the even-duration multimedia resource segments.

Exemplarily, taking the duration of the initial multimedia resource being 0 s to 35 s as an example, if the draft segment count is 4, the multimedia resource segment 1 is 0 s to 10 s, the multimedia resource segment 2 is 10 s to 20 s, the multimedia resource segment 3 is 20 s to 30 s, and the multimedia resource segment 4 is 30 s to 35 s. To ensure composition accuracy and reliability of the multimedia resource and avoid inaccurate composition caused by problems such as inaccurate segmentation, in some specific implementation examples, there are partially overlapping resources between the adjacent multimedia resource segments. For example, the multimedia resource segment 1 is 0 s to 11 s, the multimedia resource segment 2 is 9 s to 21 s, the multimedia resource segment 3 is 19 s to 31 s, and the multimedia resource segment 4 is 29 s to 35 s. Subsequently, the processors may process the corresponding multimedia resource segments, extract a processing result of 0 s to 10 s from a processing result corresponding to the multimedia resource segment of 0 s to 11 s, a processing result of 10 s to 20 s from a processing result corresponding to the multimedia resource segment of 9 s to 21 s, a processing result of 20 s to 30 s from a processing result corresponding to the multimedia resource segment of 19 s to 31 s, and a processing result of 30 s to 35 s from a processing result corresponding to the multimedia resource segment of 29 s to 35 s for composition. In summary, through the above method, each processor may cache data from a preceding frame and a following frame when performing composite processing on the corresponding multimedia resource segment, thereby effectively ensuring composition accuracy and reliability of the multimedia resource, avoiding the problems such as stuttering in the multimedia resource composition process due to inaccurate segmentation, and further ensuring composition coherence and stability of the multimedia resource.

Step B2: Segment the editing information in the multimedia editing draft according to the plurality of multimedia resource segments to obtain editing information segments corresponding to the different multimedia resource segments.

With the known multimedia resource segments, the editing information may be further segmented and is used to indicate the editing operation on the initial multimedia resource. Exemplarily, the editing information indicates a composition method between the audio and video resources and the material resource in the initial multimedia resource, and the material type is not limited. For example, the material may be an image, a text, an animation that may be played from any time point, an effect, a sticker, a filter, audio, etc., which is not repeated herein. Assuming that the initial multimedia resource is a video of 0 s to 35 s, a set time threshold is 10 s, and the processing duration of a single processor is 10 s, it is determined that 4 draft segments are needed through the above even segmentation method, indicating that 4 processors are needed. A video segment corresponding to the processor 1 is 0 s to 10 s, a video segment corresponding to the processor 2 is 10 s to 20 s, a video segment corresponding to the processor 3 is 20 s to 30 s, and a video segment corresponding to the processor 4 is 30 s to 35 s. The editing information indicates that an effect needs to be inserted within 7 s to 15 s, a text needs to be inserted within 31 s to 35 s, the editing information segments corresponding to the processor 1 and the processor 2 indicate effect insertion for the multimedia resource segments, the content of the editing information segment corresponding to the processor 3 is empty, and the editing information segment corresponding to the processor 4 indicates text insertion for the multimedia resource segment. The above is merely a simple example. During specific implementation, the editing information segments may indicate specific methods for performing the editing operation on the corresponding multimedia resource segments, such as a specific content of a text and a display position of the text, which is not repeated herein.

Step B3: Obtain a plurality of draft segments based on the plurality of multimedia resource segments and the editing information segments corresponding to the different multimedia resource segments.

In summary, through step A and step B as above, the draft segment count can be reasonably and objectively determined, that is, the number of the processors needed for the multimedia editing draft is determined, and parallel processing by the plurality of processors is efficiently and conveniently achieved, thereby further reducing composition time for the multimedia resource.

Additionally, it should be noted that the draft segment corresponding to each processor is the draft segment to be processed by the processor. For example, the processor needs to perform editing processing on the corresponding multimedia resource segment based on the editing information segment in the draft segment. However, in practical applications, the processor may be instructed to directly download the corresponding draft segment for processing, or to first download the multimedia editing draft, and then only process the corresponding draft segment in the multimedia editing draft. Exemplarily, the initial multimedia resource in the multimedia editing draft is a video of 0 s to 35 s, the editing information indicates that the composition operation needs to be performed on the initial video and a specified material, the processors 1 to 4 are needed for processing, and therefore the above four processors can only download the corresponding draft segments, for example, the processor 1 can only download the draft segment of 0 s to 10 s. The above four processors may also acquire the complete multimedia editing draft, and then only process the corresponding draft segments. For example, the processor 1 acquires a complete video of 0 s to 35 s, but only processes the video segment of 0 s to 10 s during processing, and outputs a composition result only for the draft segment of 0 s to 10 s. In summary, each processor can not only download the corresponding draft segment but also can completely download the complete multimedia editing draft, and only needs to process the draft segment in the multimedia editing draft corresponding to the processor subsequently. The method is convenient, and specifically, the needed method may be flexibly selected according to needs, which is not limited herein.

To ensure the smoothness of the final obtained target multimedia resource, this embodiment of the present disclosure provides the specific implementation example of respectively using the different processors to perform composite processing on different draft segments. Specifically, the different processors may be respectively used to download and preload different draft segments, and the different processors perform composite processing based on the respective preloaded draft segments.

Exemplarily, for each processor, the processor is used to download and preload the draft segment corresponding to the processor, and composite processing is performed on the multimedia resource segment in the draft segment based on the editing information segment in the draft segment. For example, the multimedia resource segment and the corresponding material are composited according to an operation indicated by the editing information segment. Through the preload method, it may be ensured that a preloaded segment resource can be acquired in time when first composite processing is performed, and timely processing may be performed based on the preloaded segment resource, thereby effectively avoiding the potential phenomenon of time delay and the problems such as video discontinuity caused when resource loading is performed only during processing, and preventing video smoothness from being influenced.

Through the preload method, it may be ensured that when the processor is used to perform composite processing on the corresponding draft segment, the preloaded draft segment can be acquired in time. Timely processing may be performed based on the preloaded draft segment, thereby effectively avoiding the potential phenomenon of time delay and the problems such as multimedia resource discontinuity caused when the draft segment is loaded only during processing, and preventing multimedia resource smoothness from being influenced.

In practical applications, each processor may be used to process one draft segment to obtain the corresponding target multimedia resource segment, and therefore the plurality of target multimedia resource segments can be obtained. Then, when the step of compositing the plurality of target multimedia resource segments to obtain the target multimedia resource corresponding to the multimedia editing draft, a plurality of target multimedia resources may be concatenated according to time information corresponding to different target multimedia resources, thereby obtaining the target multimedia resource corresponding to the multimedia editing draft. That is, a sequence of the plurality of target multimedia resources is determined according to the time information corresponding to each target multimedia resource, and then concatenation is performed according to the sequence, thereby obtaining the target multimedia resource matching the multimedia editing draft.

When the initial multimedia resource includes the initial video resource, to ensure audio smoothness, and avoid poor user experiences due to audio stuttering, the target multimedia resource segments corresponding to the processors do not carry an audio stream corresponding to the initial video resource. Based on this, the step of compositing the plurality of target multimedia resource segments to obtain the target multimedia resource corresponding to the multimedia editing draft includes: encoding the audio stream corresponding to the initial video resource through other processors in addition to the processors corresponding to the plurality of draft segments, to obtain an encoded audio stream; and merging the plurality of target multimedia resource segments and the encoded audio stream to obtain the target multimedia resource corresponding to the multimedia editing draft. That is, a dedicated additional processor may be used for audio stream encoding, an audio track is encoded and converted into another format from one format, and the encoding method may be determined based on the encoding information. This embodiment of the present disclosure fully considers that audio requires minimal computation and the processing speed is high, and therefore the entire audio may be separately used as a subtask for processing. That is, in addition to the corresponding processors for processing the draft segments, this embodiment of the present disclosure additionally provides a processor to centrally process the audio stream corresponding to the initial video resource, and therefore in this embodiment of the present disclosure, the total number of the processors needed for processing the multimedia editing draft may be N+1, where N denotes the draft segment count.

To facilitate understanding of the multimedia resource processing method provided in this embodiment of the present disclosure, the multimedia resource including a video is used as an example in this embodiment of the present disclosure, and the composition operation needs to be performed on the video, such as compositing materials such as a sticker and an effect, and the video, which is specifically described with reference to FIG. 2 to FIG. 4.

Firstly, referring to FIG. 2, which illustrates a schematic diagram of video composition in the related art, an overall solution for single-server composition is provided. FIG. 2 specifically illustrates that the entire video composition process is finished in one CPU. That is, materials such as a filter, a sticker, and an effect are added to the initial video, and then video stream encoding and audio stream encoding are performed to obtain a final composited video, where in FIG. 2, the final composited video is exemplified as a complete mp4. In summary, the schematic diagram shown in FIG. 2 is a video composition method commonly used in the related art.

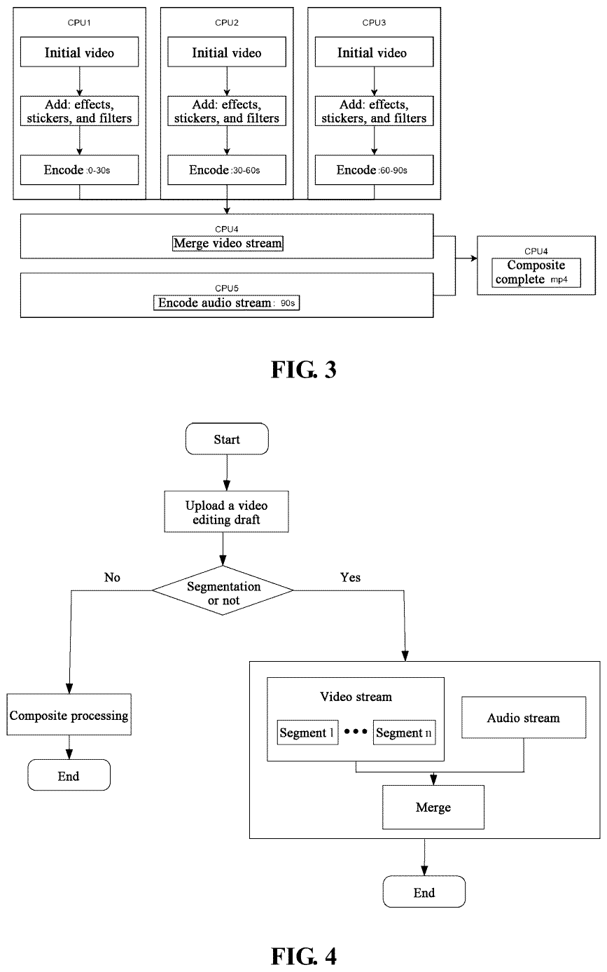

Based on FIG. 2, referring to FIG. 3, which is a schematic diagram of video composition applying this embodiment of the present disclosure, an overall solution for server segmented composition is provided. FIG. 3 specifically illustrates that the entire video composition process may be completed using a plurality of CPUs (e.g., CPU1 to CPU5). The CPU1, the CPU2, and the CPU3 respectively perform composite processing on the corresponding draft segments. That is, the CPU1 processes the draft segment of 0 s to 30 s, the CPU2 processes the draft segment of 30 s to 60 s, the CPU3 processes the draft segment of 60 s to 90 s, and the CPU4 is responsible for merging segment composited videos obtained through the CPU1 to the CPU3, which is only for video stream combination. The CPU5 is used to separately encode the audio stream of 90 s, and finally the CPU4 (which may also be the CPU5) is used to composite the complete mp4, namely the final composited video. Compared with FIG. 2, a video composition task is divided into a plurality of subtasks for parallel processing through a video composition solution shown in FIG. 3, which is apparently more efficient and consumes shorter time. The above is exemplified as the CPUs, and GPUs may also be used in practical application. No limitation is imposed herein. Compared with only using one processor for video composition in the related art, the inventor tests a large number of videos using the above method provided in this embodiment of the present disclosure, obtained results embody that the method for applying the above multimedia resource processing method provided in this embodiment of the present disclosure for video composition may significantly shorten video composition time.

For ease of understanding, reference may also be made to FIG. 4, which is a schematic flowchart of video composition, illustrating a main process of video composition. FIG. 4 emphasizes the need for separate processing of a video stream and an audio stream, where the video stream may be segmented while the audio stream needs to be processed as a whole. Specifically, after a video editing draft is uploaded, whether segmentation is performed needs to be first determined, and if not, direct composite processing is performed, thereby obtaining a final composition result. If yes, separate processing is performed according to the video stream and the audio stream, where the video stream may be divided into N video segments, and then, the processed video stream and the processed audio stream are merged to obtain a final composition result. By segmenting the video stream, a plurality of segments are subjected to parallel processing, and therefore the overall video composition efficiency can be effectively improved. The computation needed for the audio stream is simple, and therefore the audio stream is separately processed as a whole, thereby effectively ensuring the smoothness of the audio stream.

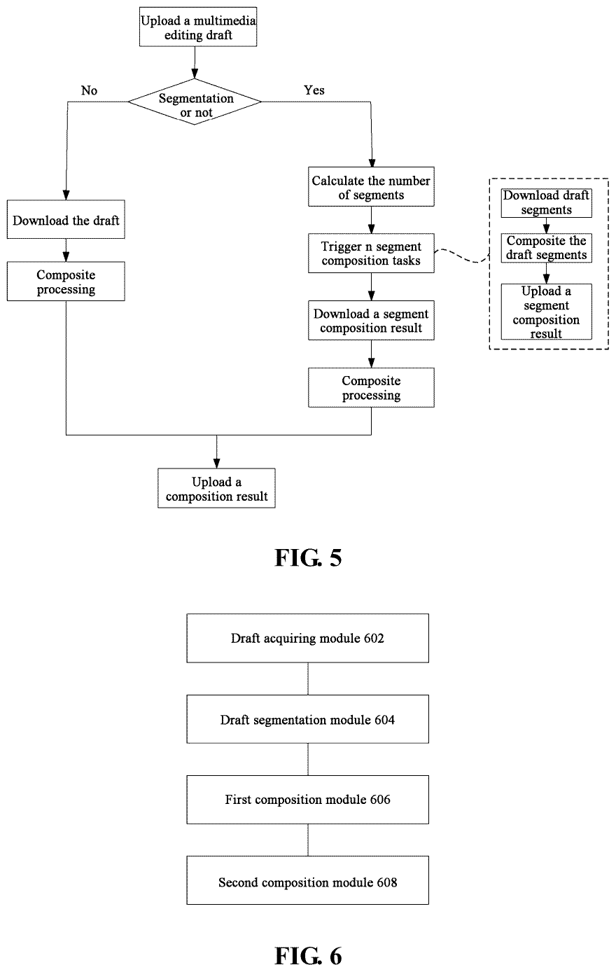

Additionally, reference may also be made to FIG. 5, which is a schematic diagram of a processing process of a multimedia editing draft, similarly illustrating a main process of composition of the multimedia editing draft. FIG. 5 emphasizes a specific method for segmenting a multimedia resource composition task into n segment composition tasks (i.e., n subtasks). For example, a multimedia editing draft uploaded by the user is transmitted on a cloud storage system, and then a processor responsible for a draft processing operation may determine whether segmentation is performed; if not, the multimedia editing draft is directly downloaded for composite processing, and if yes, the number of segments (i.e., the number of the above draft segments) needs to be further calculated, and the n segment composition tasks are triggered, where the value of n is the value of the number of the segments. Specifically, for each segment composition task, a processor needs to be allocated to the segment composition task, and the allocated processor is used to perform the steps of draft segment downloading, composition, and composition result uploading. For example, the allocated processor downloads the corresponding draft segment from the cloud storage system, performs the composite operation on the draft segment, and finally uploads a segment composition result (i.e., the above target multimedia resource segment) to a specified position (which may also be the cloud storage system or other devices or systems). Subsequently, a processor dedicated to combination may be used to download n segment composition results from the specified position, merge the segment composition results, and finally upload a composition result to a specified device or cloud. It should be noted that FIG. 5 is only an exemplary description, which should not be considered limiting. For example, the processor configured to merge the n segment composition results may be separately set, or one of n processors for processing the n segment composition tasks may be set as the processor for result combination. Through the method shown in FIG. 5, the video composition task may be divided into the plurality of segment composition tasks for parallel processing, thereby improving the video composition efficiency.

In summary, the above multimedia resource processing method provided in this embodiment of the present disclosure can effectively improve the multimedia resource composition efficiency, shorten the composition time of the multimedia resource, also well ensure stability and smoothness of the multimedia resource composition, and comprehensively enhance user experience.

Corresponding to the above multimedia resource processing method, an embodiment of the present disclosure provides a multimedia resource processing apparatus. FIG. 6 is a schematic diagram of a structure of a multimedia resource processing apparatus according to an embodiment of the present disclosure. The apparatus may be implemented through software and/or hardware, is typically integrated in an electronic device, and as shown in FIG. 6, includes:
a draft acquiring module 602, configured to acquire a multimedia editing draft to be processed, where the multimedia editing draft includes an initial multimedia resource and editing information, the editing information is used to indicate an editing operation on the initial multimedia resource, and the initial multimedia resource includes an initial video resource and/or an initial audio resource;
a draft segmentation module 604, configured to perform segmentation processing on the multimedia editing draft to obtain a plurality of draft segments, where each draft segment includes a multimedia resource segment from the initial multimedia resource and an editing information segment from the editing information, and the editing information segment is used to indicate an editing operation on the multimedia resource segment;
a first composition module 606, configured to perform, for the plurality of draft segments, composite processing on the different draft segments using different processors to obtain target multimedia resource segments corresponding to the plurality of draft segments, where the target multimedia resource segments are multimedia resources obtained after the editing operations indicated by the editing information segments are performed on the multimedia resource segments; and
a second composition module 608, configured to composite the plurality of target multimedia resource segments to obtain a target multimedia resource corresponding to the multimedia editing draft, where the target multimedia resource is a multimedia resource obtained after the editing operation indicated by the editing information is performed on the initial multimedia resource.

In summary, the above method does not directly use a single processor to obtain the target multimedia resource corresponding to the multimedia editing draft. Instead, through the method for segmenting the multimedia editing draft, the corresponding draft segments are processed in parallel using the plurality of processors, and then the target multimedia resource corresponding to the draft segment obtained by each processor is further composited, and the target multimedia resource corresponding to the multimedia editing draft is finally obtained. The parallel processing method can effectively improve the multimedia resource composition efficiency and shorten the composition time of the multimedia resource, thereby well improving user experience.

In some implementations, the draft segmentation module 604 is specifically configured to: determine a draft segment count according to a total duration of the initial multimedia resource, and perform, based on the draft segment count, segmentation processing on the multimedia editing draft to obtain a plurality of draft segments.

In some implementations, the draft segmentation module 604 is specifically configured to: acquire a target resolution corresponding to the initial multimedia resource; and determine a draft segment count according to the total duration of the initial multimedia resource and the target resolution.

In some implementations, the draft segmentation module 604 is specifically configured to: acquire a maximum segment count and a preset single-segment duration corresponding to the target resolution when the total duration is greater than a duration threshold; and determine a draft segment count according to the maximum segment count, the total duration, and the preset single-segment duration.

In some implementations, in the step of determining a draft segment count according to the maximum segment count, the total duration, and the preset single-segment duration, the draft segmentation module 604 is specifically configured to: if a ratio of the total duration to the preset single-segment duration is less than the maximum segment count, determine a draft segment count based on the ratio; and if the ratio of the total duration to the preset single-segment duration is not less than the maximum segment count, use the maximum segment count as a draft segment count.

In some implementations, the draft segmentation module 604 is specifically configured to: perform even segmentation processing on the initial multimedia resource in the multimedia editing draft based on the draft segment count to obtain a plurality of multimedia resource segments; segment the editing information in the multimedia editing draft according to the plurality of multimedia resource segments to obtain editing information segments corresponding to the different multimedia resource segments; and obtain a plurality of draft segments based on the plurality of multimedia resource segments and the editing information segments corresponding to the different multimedia resource segments.

In some implementations, there are partially overlapping resources between the adjacent multimedia resource segments.

In some implementations, the first composition module 606 is specifically configured to: use different processors to download and preload different draft segments, and perform, by the different processors, composite processing based on the respective preloaded draft segments.

In some implementations, the second composition module 608 is specifically configured to:
concatenate the plurality of target multimedia resources according to time information corresponding to the different target multimedia resources, to obtain a target multimedia resource corresponding to the multimedia editing draft.

In some implementations, the initial multimedia resource includes the initial video resource, and the target multimedia resource segments corresponding to the processors do not carry an audio stream corresponding to the initial video resource. The second composition module 608 is specifically configured to: encode the audio stream corresponding to the initial video resource through other processors in addition to the processors corresponding to the plurality of draft segments, to obtain an encoded audio stream; and merge the plurality of target multimedia resource segments and the encoded audio stream to obtain a target multimedia resource corresponding to the multimedia editing draft.

The multimedia resource processing apparatus provided in this embodiment of the present disclosure may perform the multimedia resource processing method provided in any embodiment of the present disclosure, and has the corresponding functional modules and beneficial effects for performing the method.

Those skilled in the art should clearly understand that for the convenience and brevity of descriptions, regarding the specific working process of the apparatus embodiment described above, reference may be made to the corresponding process in the method embodiment, which is not repeated herein.

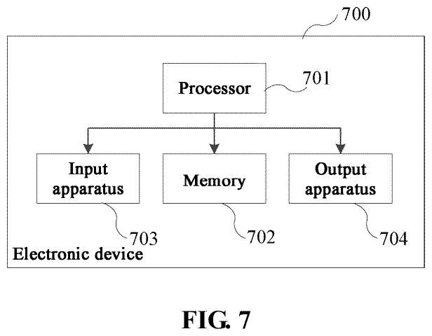

FIG. 7 is a schematic diagram of a structure of an electronic device according to an embodiment of the present disclosure. As shown in FIG. 7, the electronic device 700 includes one or more processors 701 and a memory 702.

The processor 701 may be a central processing unit (CPU) or other forms of processing units with data processing capabilities and/or instruction execution capabilities, and may control other components in the electronic device 700 to perform desired functions.

The memory 702 may include one or more computer program products. The computer program product may include various forms of computer-readable storage media, such as a volatile memory and/or a non-volatile memory. The volatile memory may include, for example, a random access memory (RAM) and/or a high-speed cache memory (cache). The non-volatile memory may include, for example, a read only memory (ROM), a hard drive, and a flash memory. The computer-readable storage medium may store one or more computer program instructions. The processor 701 may run the program instructions to implement the above multimedia resource processing method according to this embodiment of the present disclosure and/or other desired functions. The computer-readable storage medium may also store various contents such as an input signal, a signal component, and a noise component.

In an example, the electronic device 700 may also include: an input apparatus 703 and an output apparatus 704. These components are interconnected through a bus system and/or other forms of connection mechanisms (not shown).

Additionally, the input apparatus 703 may also include, for example, a keyboard and a mouse.

The output apparatus 704 may externally output various information, including determined distance information, direction information, etc. The output apparatus 704 may include, for example, a display, a speaker, a printer, a communication network and a remote output device connected to it, etc.

Certainly, for simplification, FIG. 7 only illustrates some of components of the electronic device 700 relevant to the present disclosure, and components such as a bus and an input/output interface are omitted. In addition, the electronic device 700 may also include any other appropriate component according to specific application situations.

In addition to the above method and device, an embodiment of the present disclosure may also be a computer program product, including computer program instructions. The computer program instructions, when run by a processor, cause the processor to perform the multimedia resource processing method provided in this embodiment of the present disclosure.

The computer program product may write, with any combination of one or more programming languages, program code used to perform the operations of the embodiments of the present disclosure. The programming languages include object-oriented programming languages, such as Java and C++, and further include conventional procedural programming languages, such as “C” language or similar programming languages. The program code may be executed entirely on a user computing device, partly on user equipment, as a stand-alone software package, partly on the user computing device and partly on a remote computing device, or entirely on the remote computing device or a server.

Additionally, an embodiment of the present disclosure may also be a computer-readable storage medium, having computer program instructions stored therein. The computer program instructions, when run by a processor, cause the processor to perform the multimedia resource processing method provided in this embodiment of the present disclosure.

The computer-readable storage medium may adopt any combination of one or more readable media.

The readable medium may be a readable signal medium or a readable storage medium. The readable storage medium may include, for example, but is not limited to, electric, magnetic, optical, electromagnetic, infrared, or semiconductor systems, apparatuses, or devices, or any combination of the above. More specific examples (a non-exhaustive list) of the readable storage medium include: an electrical connection with one or more wires, a portable disk, a hard drive, a random access memory (RAM), a read only memory (ROM), an erasable programmable read only memory (EPROM or a flash), optical fiber, a portable compact disc read only memory (CD-ROM), an optical storage device, a magnetic storage device, or any proper combination of the above.

An embodiment of the present disclosure further provides a computer program product including a computer program/instruction. The computer program/instruction, when executed by a processor, implements the multimedia resource processing method in this embodiment of the present disclosure.

It should be noted that herein, relational terms such as “first” and “second” are used only to distinguish one entity or operation from another and do not necessarily require or imply any actual relationship or order between these entities or operations. In addition, the terms “comprise”, “include”, or any other variations thereof are intended to cover non-exclusive inclusions, and therefore a process, a method, an article, or a device including a series of elements not only includes those elements but also includes other elements not clearly listed, or further includes elements inherent to the process, the method, the article, or the device. In the absence of further restrictions, an element specified by the phrase “including a . . . ” does not exclude the existence of other identical elements in the process, the method, the article, or the device that includes the element.

The above contents are merely specific implementations of the present disclosure, such that those skilled in the art can understand or implement the present disclosure. More modifications for these embodiments are apparent to those skilled in the art, and general principles defined herein may be implemented in other embodiments without departing from the spirit or scope of the present disclosure. Therefore, the present disclosure will not be limited by these embodiments described herein but is required to conform to a widest scope consistent with the principles and novel characteristics disclosed herein.

1. A multimedia resource processing method, comprising:
acquiring a multimedia editing draft to be processed, wherein the multimedia editing draft comprises an initial multimedia resource and editing information, the editing information is used to indicate an editing operation on the initial multimedia resource, and the initial multimedia resource comprises an initial video resource and/or an initial audio resource;
performing segmentation processing on the multimedia editing draft to obtain a plurality of draft segments, wherein the draft segments comprise multimedia resource segments from the initial multimedia resource and editing information segments from the editing information, and the editing information segments are used to indicate editing operations on the multimedia resource segments;
performing, for the plurality of draft segments, composite processing on the different draft segments using different processors respectively to obtain target multimedia resource segments corresponding to the plurality of draft segments, wherein the target multimedia resource segments are multimedia resources obtained after the editing operations indicated by the editing information segments are performed on the multimedia resource segments; and
compositing the plurality of target multimedia resource segments to obtain a target multimedia resource corresponding to the multimedia editing draft, wherein the target multimedia resource is a multimedia resource obtained after the editing operation indicated by the editing information is performed on the initial multimedia resource.

2. The method according to claim 1, wherein performing segmentation processing on the multimedia editing draft to obtain the plurality of draft segments comprises:
determining a draft segment count according to a total duration of the initial multimedia resource; and
performing the segmentation processing on the multimedia editing draft based on the draft segment count to obtain the plurality of draft segments.

3. The method according to claim 2, wherein determining the draft segment count according to the total duration of the initial multimedia resource comprises:
acquiring a target resolution corresponding to the initial multimedia resource; and
determining the draft segment count according to the total duration of the initial multimedia resource and the target resolution.

4. The method according to claim 3, wherein determining the draft segment count according to the total duration of the initial multimedia resource and the target resolution comprises:
acquiring a maximum segment count and a preset single-segment duration corresponding to the target resolution in response to the total duration being greater than a duration threshold; and
determining the draft segment count according to the maximum segment count, the total duration, and the preset single-segment duration.

5. The method according to claim 4, wherein determining the draft segment count according to the maximum segment count, the total duration, and the preset single-segment duration comprises:
in response to a ratio of the total duration to the preset single-segment duration being less than the maximum segment count, determining the draft segment count based on the ratio; and
in response to the ratio of the total duration to the preset single-segment duration being not less than the maximum segment count, determining the maximum segment count as the draft segment count.

6. The method according to claim 2, wherein performing segmentation processing on the multimedia editing draft based on the draft segment count to obtain the plurality of draft segments comprises:
performing even segmentation processing on the initial multimedia resource in the multimedia editing draft based on the draft segment count to obtain a plurality of multimedia resource segments;
segmenting the editing information in the multimedia editing draft according to the plurality of multimedia resource segments to obtain editing information segments respectively corresponding to the different multimedia resource segments; and
obtaining the plurality of draft segments based on the plurality of multimedia resource segments and the editing information segments respectively corresponding to the different multimedia resource segments.

7. The method according to claim 6, wherein there are partially overlapping resources between the adjacent multimedia resource segments.

8. The method according to claim 1, wherein performing composite processing on the different draft segments using different processors respectively comprises:
using the different processors to download and preload different draft segments respectively, and performing, by the different processors, the composite processing based on the respective preloaded draft segments.

9. The method according to claim 1, wherein compositing the plurality of target multimedia resource segments to obtain the target multimedia resource corresponding to the multimedia editing draft comprises:
concatenating the plurality of target multimedia resources according to time information respectively corresponding to the different target multimedia resources, to obtain the target multimedia resource corresponding to the multimedia editing draft.

10. The method according to claim 1, wherein the initial multimedia resource comprises the initial video resource, and the target multimedia resource segments corresponding to the processors do not carry an audio stream corresponding to the initial video resource; and
wherein compositing the plurality of target multimedia resource segments to obtain the target multimedia resource corresponding to the multimedia editing draft comprises:
encoding the audio stream corresponding to the initial video resource through another processor other than the processors corresponding to the plurality of draft segments, to obtain an encoded audio stream; and
merging the plurality of target multimedia resource segments and the encoded audio stream to obtain the target multimedia resource corresponding to the multimedia editing draft.

11. (canceled)

12. An electronic device, comprising:
a processor; and
a memory, configured to store executable instructions of the processor,
wherein the processor is configured to read the executable instructions from the memory, and the instructions, when executed by the processor, cause the electronic device to:
acquire a multimedia editing draft comprises an initial multimedia resource and editing information, the editing information is used to indicate an editing operation on the initial multimedia resource, and the initial multimedia resource comprises an initial video resource and/or an initial audio resource;
perform segmentation processing on the multimedia editing draft to obtain a plurality of draft segments, wherein the draft segments comprise multimedia resource segments from the initial multimedia resource and editing information segments from the editing information, and the editing information segments are used to indicate editing operations on the multimedia resource segments;
perform, for the plurality of draft segments, composite processing on the different draft segments using different processors respectively to obtain target multimedia resource segments corresponding to the plurality of draft segments, wherein the target multimedia resource segments are multimedia resources obtained after the editing operations indicated by the editing information segments are performed on the multimedia resource segments; and
composite the plurality of target multimedia resource segments to obtain a target multimedia resource corresponding to the multimedia editing draft, wherein the target multimedia resource is a multimedia resource obtained after the editing operation indicated by the editing information is performed on the initial multimedia resource.

13. A non-transitory computer-readable storage medium, wherein the storage medium stores a computer program, and the computer program, when executed, causes a computer to:
acquire a multimedia editing draft to be processed, wherein the multimedia editing draft comprises an initial multimedia resource and editing information, the editing information is used to indicate an editing operation on the initial multimedia resource, and the initial multimedia resource comprises an initial video resource and/or an initial audio resource;
perform segmentation processing on the multimedia editing draft to obtain a plurality of draft segments, wherein the draft segments comprise multimedia resource segments from the initial multimedia resource and editing information segments from the editing information, and the editing information segments are used to indicate editing operations on the multimedia resource segments;
perform, for the plurality of draft segments, composite processing on the different draft segments using different processors respectively to obtain target multimedia resource segments corresponding to the plurality of draft segments, wherein the target multimedia resource segments are multimedia resources obtained after the editing operations indicated by the editing information segments are performed on the multimedia resource segments; and
composite the plurality of target multimedia resource segments to obtain a target multimedia resource corresponding to the multimedia editing draft, wherein the target multimedia resource is a multimedia resource obtained after the editing operation indicated by the editing information is performed on the initial multimedia resource.

14. (canceled)

15. The electronic device according to claim 12, wherein the instructions causing the electronic device to perform segmentation processing on the multimedia editing draft to obtain the plurality of draft segments further cause the electronic device to:
determine a draft segment count according to a total duration of the initial multimedia resource; and
perform the segmentation processing on the multimedia editing draft based on the draft segment count to obtain the plurality of draft segments.

16. The electronic device according to claim 15, wherein the instructions causing the electronic device to determine the draft segment count according to the total duration of the initial multimedia resource further cause the electronic device to:
acquire a target resolution corresponding to the initial multimedia resource; and
determine the draft segment count according to the total duration of the initial multimedia resource and the target resolution.

17. The electronic device according to claim 16, wherein the instructions causing the electronic device to determine the draft segment count according to the total duration of the initial multimedia resource and the target resolution further cause the electronic device to:
acquire a maximum segment count and a preset single-segment duration corresponding to the target resolution in response to the total duration being greater than a duration threshold; and
determine the draft segment count according to the maximum segment count, the total duration, and the preset single-segment duration.

18. The electronic device according to claim 17, wherein the instructions causing the electronic device to determine the draft segment count according to the maximum segment count, the total duration, and the preset single-segment duration further cause the electronic device to:
in response to a ratio of the total duration to the preset single-segment duration being less than the maximum segment count, determine the draft segment count based on the ratio; and
in response to the ratio of the total duration to the preset single-segment duration being not less than the maximum segment count, determine the maximum segment count as the draft segment count.

19. The electronic device according to claim 15, wherein the instructions causing the electronic device to perform segmentation processing on the multimedia editing draft based on the draft segment count to obtain the plurality of draft segments further cause the electronic device to:
perform even segmentation processing on the initial multimedia resource in the multimedia editing draft based on the draft segment count to obtain a plurality of multimedia resource segments;
segment the editing information in the multimedia editing draft according to the plurality of multimedia resource segments to obtain editing information segments respectively corresponding to the different multimedia resource segments; and
obtain the plurality of draft segments based on the plurality of multimedia resource segments and the editing information segments respectively corresponding to the different multimedia resource segments.

20. The electronic device according to claim 19, wherein there are partially overlapping resources between the adjacent multimedia resource segments.

21. The electronic device according to claim 12, wherein the instructions causing the electronic device to perform composite processing on the different draft segments using different processors respectively further cause the electronic device to:
use the different processors to download and preload different draft segments respectively, and perform, by the different processors, the composite processing based on the respective preloaded draft segments.

22. The electronic device according to claim 12, wherein the instructions causing the electronic device to composite the plurality of target multimedia resource segments to obtain the target multimedia resource corresponding to the multimedia editing draft further cause the electronic device to:
concatenate the plurality of target multimedia resources according to time information respectively corresponding to the different target multimedia resources, to obtain the target multimedia resource corresponding to the multimedia editing draft.
